(19) United States
(12) Patent Application Publication
(10) Pub. No.: US 2009/0021527 A1
(43) Pub. Date: Jan. 22, 2009

(54) METHOD FOR DISPLAYING BITMAP WITH ADDITIONAL COLORS

(75) Inventor: CHI-KUEI CHANG, Tu-Cheng (TW)

Correspondence Address: PCE INDUSTRY, INC.;ATT. CHENG-JU CHIANG, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/013,374

(22) Filed: Jan. 11, 2008

(30) Foreign Application Priority Data
Jul. 17, 2007 (CN) 200710201100.0

(51) Int. Cl. G09G 5/02

(52) U.S. Cl. 345/605

(57) ABSTRACT

An exemplary method for displaying bitmap with additional colors, includes: reading a bitmap and a first palette associated with the bitmap from a memory; dividing the bitmap into a color-unchanging portion and a color-changing portion; reading a second palette from the memory; associating the color-changing portion with the second palette; and displaying the color-unchanging portion using colors from the first palette and the color-changing portion using colors from the second palette.

### BACKGROUND

1. Technical Field

The present invention relates to a method for displaying a bitmap with additional colors.

2. Description of Related Art

Generally, the number of colors available in a bitmap is determined by the bit depth of the pixels of the bitmap, for example, 4 bits (bit depth) allow 16 colors, and 8 bits allow 256 colors. This means: in order to enjoy a more colorful picture, more bits are required for each pixel, and more memory space is required to store the bitmap.

Therefore, it is desirable to provide a method, which can overcome the above mentioned problem.

### SUMMARY

In a present embodiment, a method for displaying a bitmap with additional colors includes: reading a bitmap and a first palette associated with the bitmap from a memory; dividing the bitmap into a color-unchanging portion and a color-changing portion; reading a second palette from the memory; associating the color-changing portion with the second palette; and displaying the color-unchanging portion using colors from the first palette and the color-changing portion using colors from the second palette.

Other advantages and novel features will be drawn from the following detailed description of at least one preferred embodiment, when considered in conjunction with the attached drawings.

### BRIEF DESCRIPTION OF THE DRAWINGS

FIG. 1 is a functional diagram of a digital still camera, according to an exemplary embodiment.

FIG. 2 is a flow chart of a method for displaying a bitmap with additional colors.

FIG. 3 is a schematic view of a bitmap and two palettes stored in the camera of FIG. 1, wherein the bitmap is associated with one of the palettes.

FIG. 4 is a schematic view of the bitmap and the two palettes of FIG. 3, but the bitmap is divided into two portions, and each portion is associated with one palette.

### DETAILED DESCRIPTION OF THE EMBODIMENTS

Embodiments of the present method will be described in detail below with reference to the drawings.

The present method can be implemented by software, hardware, or combination of software and hardware, and can be performed by an electronic device, such as a portable communication device (e.g., cellular phone or personal digital assistant), a personal computing device (e.g., laptop computer or thin client controller), or a personal entertainment device (e.g., gaming device, media player, digital still camera, or video camera), which provides a user interface with a display configured to display a bitmap.

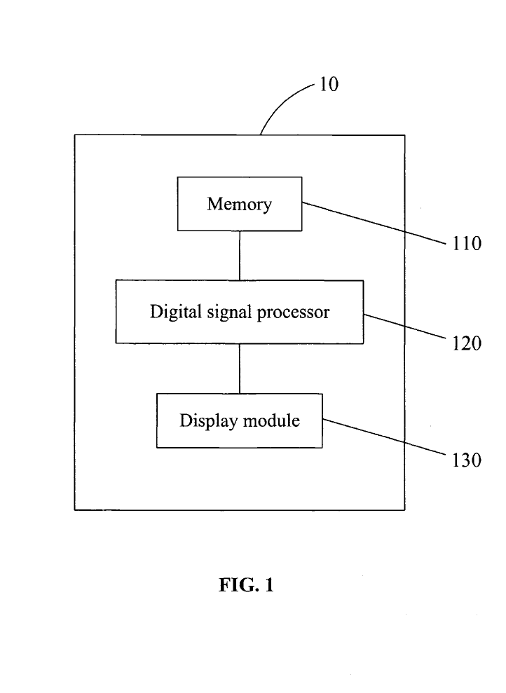

Referring to FIG. 1, in this embodiment, the electronic device is a digital still camera (DSC) 10. The DSC 10 comprises a memory 110, a digital signal processor (DSP) 120, and a display module 130. The memory 110 is configured for storing a bitmap and two palettes therein. The DSP 120 is configured for performing the present method. The display module 130 is configured for displaying the bitmap with colors from the two palettes.

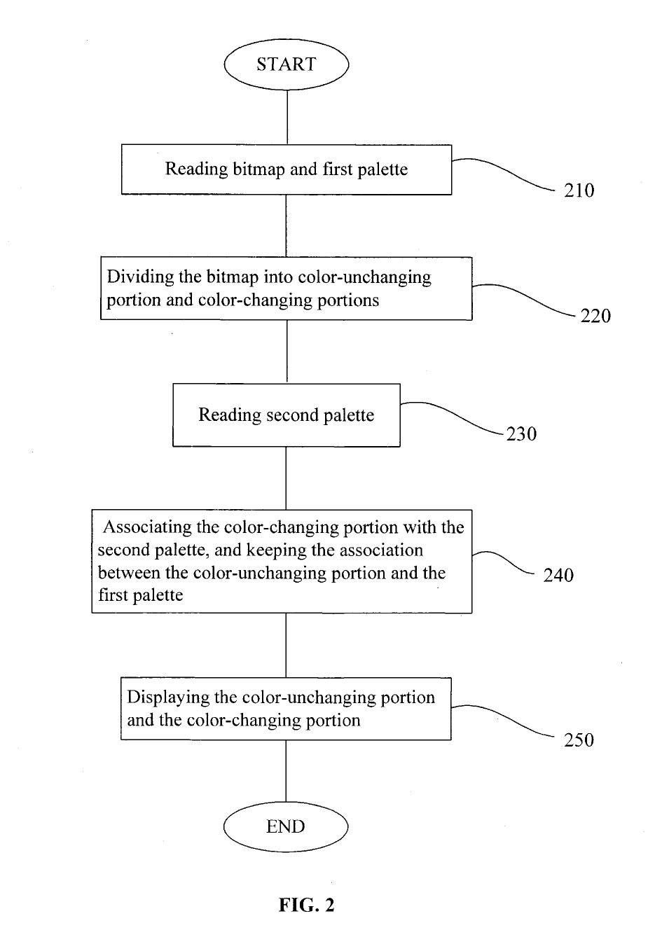

Referring to FIGS. 2˜4, a method for displaying a bitmap with additional colors, according to an exemplary embodiment, includes the following operations 210˜250.

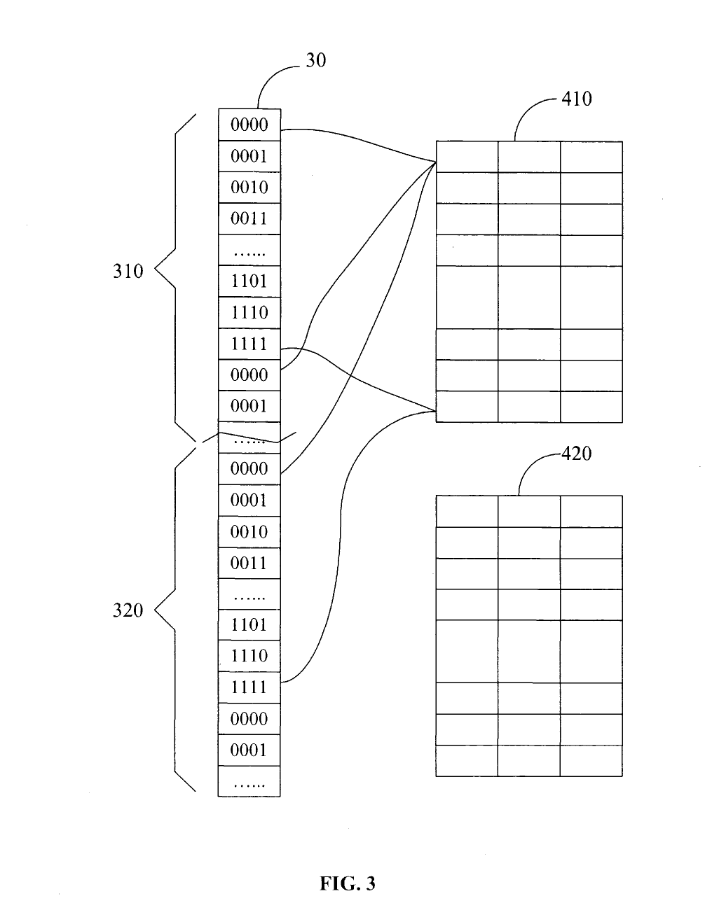

Operation 210: reading a bitmap 30 and a first palette 410 from a memory 110, where the bitmap 30 is associated with the first palette 410. In detail, the operation 210 can be carried out by the DSP 120. The bitmap 30 to be displayed is a 4-bit icon or picture stored in the memory 110 and will be processed by the DSP 120, and displayed as, for example, a representation of a virtual key by the display module 130. The first palette 410 provides 16 (or more in other embodiments) indexed colors. Generally, each color from a palette corresponds to a pixel value. As shown in FIG. 3, pixels of value 0000 of the bitmap 30 correspond to the first entry of the first palette 410; pixels of value 0001 of the bitmap 30 correspond to the second entry of the first palette 410, and so on.

Operation 220: dividing the bitmap 30 into a color-unchanging portion 310 and a color-changing portion 320. Specifically, the operation 420 can be carried out by the DSP 120 according to user preferences or recommendations of the manufacturer. As shown in FIG. 3, the color-unchanging portion 310 and the color-changing portion 320 are still associated with the first palette 410.

Operation 230: reading a second palette 420 from the memory 110.

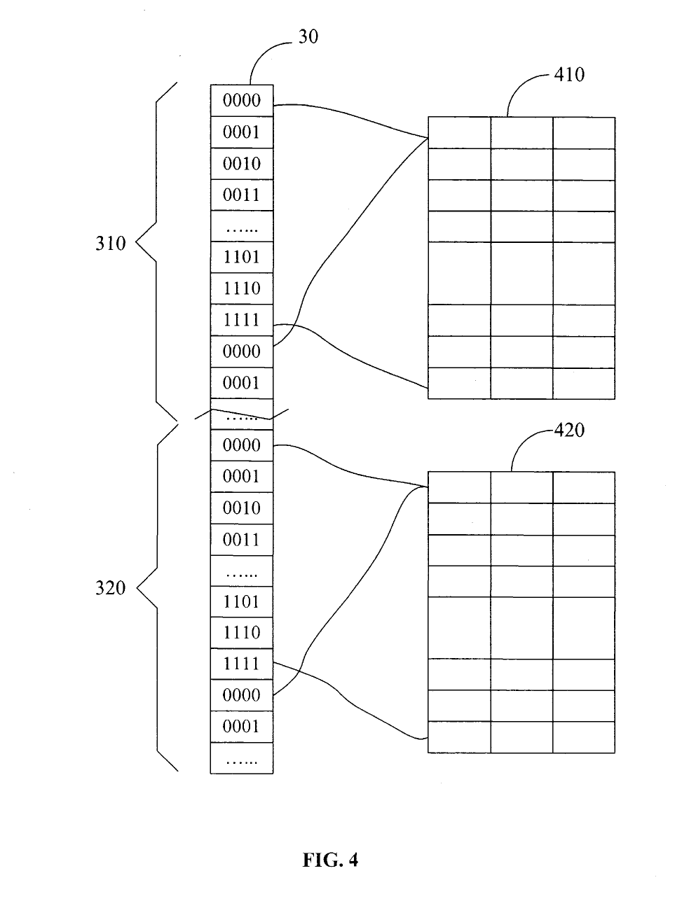

Operation 240: associating the color-changing portion 320 with the second palette 420, and keeping the association between the color-unchanging portion 310 and the first palette 410. FIG. 4 illustrates the pixels of the color-unchanging portion 310 correspond to entries of the first palette 410 and the pixels of the color-changing portion 320 correspond to entries of the second palette 420. In detail, the pixels of value 0000 of the color-unchanging portion 310 correspond to the first entry of the first palette 410, the pixels of value 0001 of the color-unchanging portion 310 correspond to the second entry of the first palette 410, and so on. However, the pixels of value 0000 of the color-changing portion 320 correspond to the first entry of the additional palette 420, the pixels of value 0001 of the at least color-changing portion 320 correspond to the second entry of the second palette 420, and so on. The colors corresponding to the entries corresponded with the pixels of the color-changing portion 320 are different from the colors corresponding to the entries corresponded with the pixels of the color-unchanging portion 310. That is, the colors from the second palette 420 used by the pixels of the color-changing portion 320 are different from the colors from the first palette 410 used by the pixels of the color-unchanging portion 310.

Operation 250: displaying the color-unchanging portion 310 using colors from the first palette 410 and the color-changing portion 320 using colors from the second palette 420 on a display module 130. It is presumed that the color corresponding to the first entry of the first palette 410 is green and the color corresponding to the first entry of the second palette 420 is brown, thus the pixels of value 0000 of the color-unchanging portion 310 are thus green on the display module 130 and the pixels of value 0000 of the color-changing portion 320 are thus brown on the display module 130. Similarly, other pixels of different values of the different portions 310, 320 can be respectively displayed with two different colors on the display module 130.

Clearly, the method provides a greater range of colors for displaying a bitmap without increasing the bit depth of the bitmap, thereby allowing greater freedom in designing bitmaps for display in devices using the method.

It will be understood that the above particular embodiments and methods are shown and described by way of illustration only. The principles and features of the present invention may be employed in various and numerous embodiments thereof without departing from the scope of the invention as claimed. The above-described embodiments illustrate the scope of the invention but do not restrict the scope of the invention.

What is claimed is:

1. A method for displaying a bitmap with additional colors, comprising:
reading a bitmap and a first palette associated with the bitmap;
dividing the bitmap into a color-unchanging portion and a color-changing portion;
reading a second palette;
associating the color-changing portion with the second palette and keeping the association between the color-unchanging portion and the first palette; and
displaying the color-unchanging portion using colors from the first palette and the color-changing portion using colors from the second palette.

2. The method as claimed in claim 1, wherein the colors used by the pixels of the color-changing portion are different from the colors used by the pixels of the color-unchanging portion.
